(19) United States
(12) Patent Application Publication
(10) Pub. No.: US 2011/0106363 A1
(43) Pub. Date: May 5, 2011

(54) Arrangement and Method for Controlling a Drive of an Automotive, Driverless Transportation Device

(75) Inventor: Oswald Müller, Glauburg (DE)

(73) Assignee: Siemens AG, Munchen (DE)

(21) Appl. No.: 12/915,858

(22) Filed: Oct. 29, 2010

(30) Foreign Application Priority Data
Oct. 30, 2009 (EP) EP09013664.9

(51) Int. Cl. G05D 1/00

(52) U.S. Cl. 701/28

(57) ABSTRACT

An arrangement and a method for controlling a drive of an automotive, driverless transportation device, wherein the drive of a driverless transportation device or the drives of a plurality of driverless transportation device is or are controlled by means of a stationary control device. Here, a chain of light sources which is embodied as a running light is arranged along a route of the driverless transportation device, wherein at least two optical sensors for sensing the running light are arranged one behind the other on the driverless transportation device. The at least two sensors are connected to the drive of the driverless transportation device such that the driverless transportation device essentially synchronously follows at least one illuminated segment of the running light, and the stationary control device is configured to control the running light. As a result, it is possible to eliminate the mechanical drag chain conveyors.

### BACKGROUND OF THE INVENTION

1. Field of the Invention

The invention relates to an arrangement for controlling a drive of an automotive, driverless transportation device, and to a method for controlling the drive of the automotive, driverless transportation device.

2. Description of the Related Art

During progressive automization of transportation tasks, i.e., in the field of fabricating automobiles and other goods, use is frequently made of driverless transportation devices. For example, electric overhead tracks (EHB), a telpher system, are used for transporting vehicle bodies and attachment parts in manufacturing lines of the automobile industry. These transportation devices or electrical monorail systems (EMS) are generally composed of a rail system and associated, usually suspended, vehicles. These transportation devices have their own electric drive and are supplied with electrical energy by current collectors (sliders) which are guided along a multi-phase power rail system.

Typically, work is performed on the respectively conveyed products in special driving areas (fabrication areas). In such driving areas, there is often a requirement for the driverless transportation device to move at constant speeds and/or at constant intervals from one another. This requirement can be met by virtue of the fact that the driverless transportation devices are each provided with a numerical controller which communicates with an external (stationary) controller and respectively actuates the drive of the driverless transportation device such that the driverless transportation device moves at the predefined speed and/or synchronously with respect to one another. Here, a precondition for the application of such a procedure is that each driverless transportation device is equipped with a correspondingly powerful controller, such as a microprocessor system. However, in many simple driverless transportation systems this is often not the case. In such cases, simple drives are often used, which are controlled electromechanically by magnetic incremental switches using control elements which are permanently mounted on the route. Here, a distinction is often made only between the states of “travel” and “stop”, and a rear-end collision protection switch avoids a collision between two driverless transportation devices by switching off one or more of the driverless transportation devices.

In order to avoid the need to perform a costly process of equipping all driverless transportation devices with one alphanumeric controller each, or the like, it is known in conventional systems to provide a mechanical drag chain conveyor, such as a circulating chain, in the special driving areas in which a synchronous and/or constant travel of the driverless transportation device is required. In these special fabrication areas, the driverless transportation device's own drive is then decoupled and the driverless transportation devices are rigidly coupled to the mechanical drag chain conveyor. Consequently, all the coupled driverless transportation devices are moved synchronously and equidistantly. The driverless transportation devices are then decoupled again from the drag chain conveyor at the end of the special fabrication areas and resume their autonomous operation. A disadvantage of this solution is that a separate drive in the form of the drag chain conveyor must be provided for each of the special driving areas. Although the driverless transportation devices are therefore already equipped with their own drive, coupling stations and decoupling stations, the additional drag chain conveyor, entraining devices for the driverless transportation devices and an additional energy supply etc. have to be additionally provided for the special fabrication areas in question. Here, variable speeds and start/stop functions are controlled by a stationary system controller with the speed regulator of the drive of the drag chain conveyor (drag chain).

### SUMMARY OF THE INVENTION

It is therefore an object of the present invention to provide a structurally simple and reliable controller for driverless transportation devices in such special fabrication areas.

This and other objects and advantages are achieved by an arrangement and method in accordance with the invention which provide, instead of the mechanical drag chain conveyor, i.e., the coupling of the driverless transportation device to a mechanical entraining device, an optical “entraining signal” comprising light of a running light tube or the like which is mounted in the running rail. The velocity and the start/stop functions are controlled by the actuation of a light sequence or sequences of the light tube. The evaluation of the light signals of the running light tube is actuated at the one or more driverless transportation device using a corresponding simple sensor system, which actuates, for example, a power converter of the drive which is already present.

The object is achieved, in particular, by an arrangement for controlling a drive of an automotive, driverless transportation device, where the drive of a driverless transportation device or the drives of a plurality of driverless transportation devices is or are controlled by a stationary control device. Here, a chain of light sources (segments), which comprises a running light, is arranged along a route of the driverless transportation device, where at least two optical sensors for sensing the running light are arranged one behind the other in the direction of movement on the driverless transportation device, where the at least two sensors are connected to the drive of the driverless transportation device such that the driverless transportation device essentially synchronously follows an illuminated segment of the running light, and where the stationary control device is configured to control the running light. With such an arrangement, significant savings can be obtained in system construction for arrangements with driverless transportation devices, such as in the fabrication of automobiles. Due to a relatively low outlay of electrical components, the requirement of additional drag chain conveyors is obviated. Additional unlocking and locking stations (coupling and decoupling stations) can also be eliminated. The technical complexity on the part of the driverless transportation device is also low since only the (usually binary) signals of the light sensors have to be evaluated. As a result, the use of simple controllers, such as simple “frequency converters” with binary auxiliary logic as vehicle controller, is possible.

The object is also achieved by a method for controlling movement of one or more driverless transportation devices along a route. Here, the movement of the one or more driverless transportation devices is predefined by a stationary controller. In this context, the stationary controller actuates a chain of light sources comprising a running light along the route, where the speed and the position of the active light segments for the running light represents a setpoint presetting for the one or more driverless transportation devices and the running light is sensed by at least two optical sensors of at least one of the driverless transportation devices, and where the optical sensors are arranged one behind the other in the direction of transport. Here, the output signals of the at least two optical sensors are used to control a drive of the at least one driverless transportation device, where the sensors are connected to the drive such that an essentially synchronous movement of the at least one driverless transportation device with an illuminated segment (light source) of the running light occurs. The advantages of the arrangement according to the invention can be implemented by applying this method.

The driverless transportation device advantageously includes a speed regulator which is actuated by the at least two sensors. In this context, in cases in which the two sensors arranged one behind the other each detect an active light segment, the current velocity of the driverless transportation device is advantageously retained, where synchronous travel is assumed. Given different states of the output signal of the at least two optical sensors, the speed regulator accelerates or brakes correspondingly. Here, nonsynchronous travel is assumed. In cases in which none of the sensors detect a light signal, the one or more driverless transportation device(s) is/are advantageously stopped. In particular, in the cases in which the segments are each composed of a plurality of individual light sources and the individual light sources of the segments are at a significant distance from one another, the output signals of the optical sensors are advantageously subjected to low pass filtering.

The stationary controller is advantageously configured to accelerate and/or brake the one or more driverless transportation device to bring about variable control of the speed of the running light. Here, the running light can also be divided along the route into different route segments, where the speed and the “phase position” of the active elements of the running light chain are actuated separately in each of the route segments.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of an arrangement according to the invention is explained below with reference to the drawings, in which:

FIG. 1 is a schematic illustration of a driverless transportation device having a mechanical drag chain conveyor in an arrangement according to the prior art;

FIG. 2 is a schematic illustration of a driverless transportation device having a controller provided by a running light arrangement in accordance with the invention;

FIG. 3 is a schematic illustration of four different operating states of the relationship between active segments of the running light arrangement and at least two optical sensors in accordance with the invention; and

FIG. 4 is a flow chart of a method in accordance with an embodiment of the invention.

### DETAILED DESCRIPTION OF THE PRESENTLY PREFERRED EMBODIMENTS

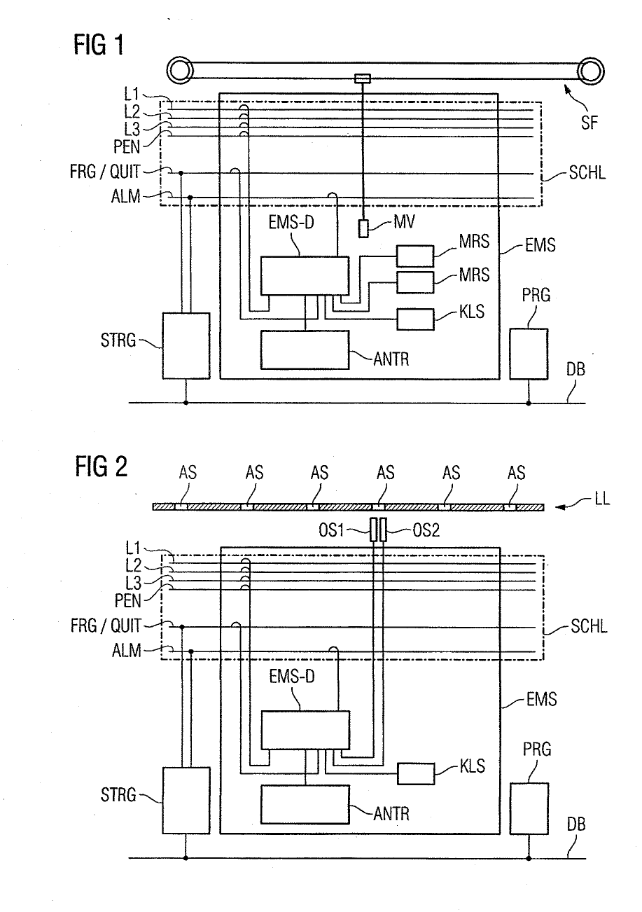

FIG. 1 is a schematic illustration of an automotive, driverless transportation device EMS (“electrical monorail system”) in an arrangement according to the prior art. Here, the transportation device EMS is connected by sliders (current collectors) to a stationary power rail system SCHL, which is equipped both with the conductors L1, L2, L3, PEN for supplying energy and with two further conductors FRG/QUIT (“enable”/“acknowledge”) and ALM (“alarm”). The stationary conductors of the power rail system SCHL are connected by sliding contacts to a controller EMS-D (“electrical monorail system-driver”) of the driverless transportation device EMS, which controller EMS-D in turn controls a drive ANTR of the transportation device EMS. In addition, the controller EMS-D is connected to the sensors MRS, KLS, where the sensors MRS (“magnetic incremental switch”) are activated by stationary activation devices (“cams”) on the route by movement of the transportation device EMS, and can easily receive start, stop and speed commands. The sensor KLS (“collision”) switches the drive ANTR off when there is an imminent collision (“rear-end collision”) with another transportation device on the same route. In the present exemplary embodiment, it is assumed that the transportation device EMS moves in a driving area (special driving area) which requires movement which is uniform and equidistant from other transportation devices. For this purpose, the transportation device EMS in the prior art is connected to a drag chain conveyor SF by a mechanical connection MV, where the drag chain conveyor SF is connected to a stationary controller STRG and is actuated by this controller STRG. Here, the drive ANTR is temporarily deactivated. The controller STRG is connected through a data link DB to a programming device PRG.

In the text which follows, an explanation of the way in which the mechanical drag chain conveyor SF and the mechanical connection MV is replaced by a running light device LL and optical sensors OS1, OS2 is given with reference to FIG. 2. In this context, identical reference signs of the three Figures each denote the same technical device.

The running light LL which is illustrated in FIG. 2 and which has the illuminated active segments AS is controlled by the stationary controller STRG. Here, the controller STRG specifies the speed (frequency) and the position (phase) of the light sources of the running light LL which are alternately actuated in the time profile. As illustrated in FIG. 2, in one advantageous embodiment of the invention, the active segments AS are arranged periodically and equidistantly. In other embodiments of the invention, which require more complex wiring and control of the running light LL, it is, however, also possible, for example, to provide in each case a separate active segment AS for each of the transportation devices EMS in question. While in the solution illustrated the two optical sensors OS1, OS2 are each intended to sense the same active segment of the active segments AS, it is possible, in particular in the case of a periodic configuration of the running light LL, for each of the optical sensors OS1, OS2 to “pursue” a different active segment of the active segments AS which move along synchronously.

The optical sensors OS1, OS2 are logically linked to the controller EMS-D of the transportation device EMS, where the controller EMS-D is equipped with an evaluation logic for evaluating the signals which are output by the optical sensors OS1, OS2. In the present advantageous embodiments, the optical sensors OS1, OS2 each supply a binary output signal. Consequently, a distinction is made only between the states “light” (logic “1”) and “no light” (logic “0”). In accordance with the disclose embodiments, this gives rise to better functional reliability than in other embodiments in which, for example, gray scales (variable brightness values) are sensed. In further advantageous embodiments, the optical sensors OS1, OS2 can be provided with optical filters which allow, for example, only individual spectral components of the light emitted by the active segments AS to pass through. Here, spectral ranges which are not emitted or only emitted to a small degree by the customary lighting devices of industrial fabrication systems (luminescent lamps, gas discharge lamps) are advantageously used. It is likewise possible, for the purpose of filtering out external stray light, to provide the optical sensors OS1, OS2 and the surface of the running light LL with pole filters which are aligned with one another and which only allow a specific polarization plane (for example horizontal, vertical or one of the two possible polar directions) of the light to pass through.

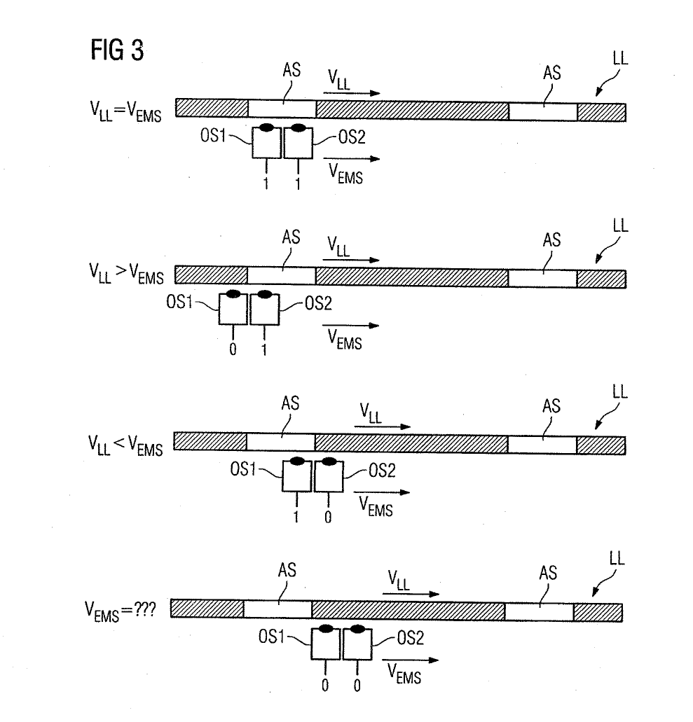

The controller EMS-D (i.e., a power converter with a plurality of control inputs) of the driverless transportation device EMS and the evaluation logic which is contained therein for the optical sensors OS1, OS2 is wired here such that the transportation device EMS follows the moving active segments AS of the running light LL. The method of functioning of the evaluation logic is illustrated for a simple case in FIG. 3. Here, a distinction is made between four different operating states. The case which is illustrated at the top in FIG. 3 occurs when the running light LL and the active segments AS contained therein and the transportation device EMS with the optical sensors OS1, OS2 move continuously at the same speed (synchronously) and the two optical sensors OS1, OS2 each detect light of an active segment AS. Here, both optical sensors OS1, OS2 supply a logic “1” as a binary output signal. As previously explained, the optical sensors OS1, OS2 can, in contrast to the illustration in FIG. 3, also be positioned opposite various active segments AS of the running light LL. Here, the mounting distance between the optical sensors OS1, OS2 is advantageously an integral multiple of the distance between the active segments AS.

Assuming the previously described “steady-state” case, in which an identical speed of the transportation device EMS and of the running light LL is assumed, the position of the transportation device EMS has dropped back slightly behind the position of the active segment AS in the second illustrated case, which results from the fact that the optical sensor OS1 no longer receives light from the active segment AS, and the optical sensor OS1 therefore outputs a binary “0”. The evaluation logic of the controller EMS-D detects this and increases the current of the drive ANTR to increase the speed of the transportation device EMS to such an extent that the initial described state is restored. At the third position in FIG. 3, the reverse case is analogously illustrated, where the transportation device EMS is running in advance of the active segment AS. In such a case, the drive energy of the drive ANTR is throttled by the controller EMS-D until the initially described state is restored. In one advantageous embodiment, the evaluation logic of the controller EMS-D contains a numerical controller (for example PID controller) which is set such that the speed and the position (“phase”) of the transportation device EMS settles to the setpoint variable predefined by the running light LL.

At the last point in the illustration in FIG. 3, the case is illustrated in which none of the optical sensors OS1, OS2 detects an active segment AS. This can occur, for example, when a fault is present in the running light LL if (as illustrated) the optical sensors OS1, OS2 are moved out of a “capture range” of the active segments AS or if some other fault is present, such as due to soiling or failure of the sensors. In such a case, it is possible to react, for example, by performing an immediate “emergency stop” of the transportation device EMS. However, the transportation device EMS can also be moved on at a low speed for a limited time period with the expectation that the optical sensors OS1, OS2 will move again into the area of one of the active segments AS and “lock in”.

In a further embodiment of the invention which is, however, structurally more complex, the segments of the running light LL are not “hard” wired, i.e., they are not only switched on and off in a binary manner but are also regulated in terms of their brightness in a quasi-continuous manner. The regulating behavior of the evaluation logic in the controller EMS-D can be improved in conjunction with optical sensors OS1, OS2, which output more detailed information about the detected brightness (e.g., with a resolution of 4 or 8 bits). In particular, the “transient oscillation” of the movement of the transportation device EMS as it moves into such a special fabrication area in which the running light controller is used can be shortened and the movement can additionally be configured with less pronounced “harmonics”.

On the entry into such a special fabrication area, the speed of the running light LL can be advantageously adapted to the “autonomous” speed of the transportation device EMS and then continuously caused to approach the setpoint speed. Jumps in speed and load peaks are therefore avoided.

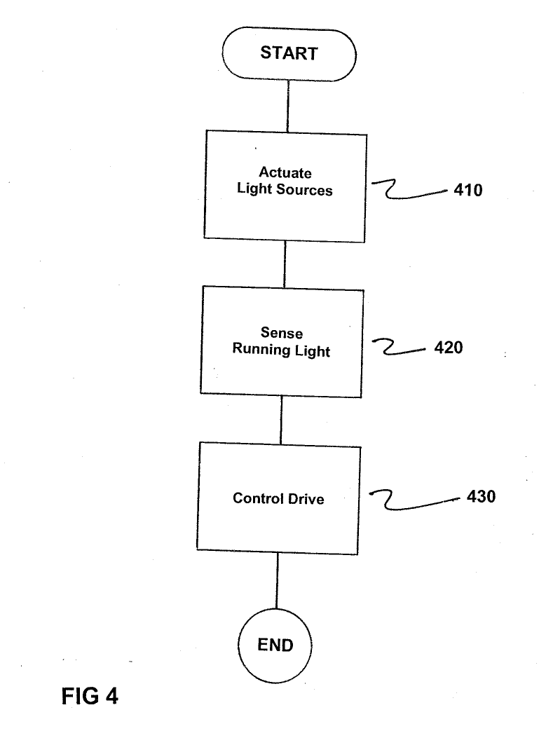

FIG. 4 is a flow chart of a method for controlling the movement of at least one driverless transportation device along a route, where the movement of the at least one driverless transportation device is predefined by a stationary controller. The method comprises actuating, by the stationary controller, a chain of light sources comprising a running light along the route, as indicated in step 410.

Here, the speed and a position of at least one illuminated segment of the running light represents a preset setpoint for at least one driverless transportation device.

The running light is then sensed by a plurality of optical sensors of the at least one of the driverless transportation device, as indicated in step 420. Here, each of the plurality of optical sensors is arranged one behind another in a direction of transport along the route.

A drive of the at least one driverless transportation device is now controlled by output signals of each of the plural optical sensors, as indicated in step 430. Here, each of the plurality of optical sensors is connected to the drive such that an essentially synchronous movement of the at least one driverless transportation device with at least one illuminated segment of the running light occurs.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. An arrangement for controlling a drive of an automotive, driverless transportation device, comprising:
a stationary control device configured to control at least one drive at least one driverless transportation device;
a chain of light sources comprising a running light arranged along a route of said at least one driverless transportation device; and
a plurality of optical sensors configured to sense said running light and arranged one behind another in a direction of movement on said at least one driverless transportation device;
wherein each of said plural optical sensors is connected to one of said at least one drive of the at least one driverless transportation device such that the at least one driverless transportation device essentially synchronously follows at least one illuminated segment of the running light; and
wherein said stationary control device is configured to control the running light.

2. The arrangement as claimed in patent claim 1, wherein each said driverless transportation device includes a speed regulator for the drive, the speed regulator being controllable by said plural optical sensors.

3. The arrangement as claimed in claim 1, wherein each of said plural optical sensors comprises a light sensor having a binary output signal.

4. The arrangement as claimed in claim 1, wherein said at least one drive is configured to perform an emergency stop when none of said plural optical sensors detects an illuminated segment of said at least one illuminated segment of said running light.

5. The arrangement as claimed in claim 1, wherein said stationary controller is configured to accelerate and brake each said at least one driverless transportation device by controlling a speed of the running light.

6. A method for controlling the movement of at least one driverless transportation device along a route, a movement of the at least one driverless transportation device being predefined by a stationary controller, the method comprising:
actuating, by the stationary controller, a chain of light sources comprising a running light along the route, a speed and a position of at least one illuminated segment of the running light representing a preset setpoint for at least one driverless transportation device;
sensing, by a plurality of optical sensors of the at least one of the driverless transportation device, the running light, each of the plural optical sensors being arranged one behind another in a direction of transport along the route; and
controlling, by output signals of each of the plural optical sensors, a drive of the at least one driverless transportation device, each of the plural optical sensors being connected to the drive such that an essentially synchronous movement of the at least one driverless transportation device with at least one illuminated segment of the running light occurs.
